(19) United States
(12) Patent Application Publication
(10) Pub. No.: US 2025/0294134 A1
(43) Pub. Date: Sep. 18, 2025

(54) TASK-ORIENTED VIDEO SEMANTIC CODING SYSTEM

(71) Applicants: Douyin Vision Co., Ltd., Beijing (CN); Bytedance Inc., Los Angeles, CA (US)

(72) Inventors: Guangqi Xie, Beijing (CN); Xin Li, Beijing (CN); Zhibo Chen, Beijing (CN); Li Zhang, San Diego, CA (US); Kai Zhang, San Diego, CA (US); Yue Li, San Diego, CA (US)

(21) Appl. No.: 19/225,862

(22) Filed: Jun. 2, 2025

Related U.S. Application Data
(63) Continuation of application No. PCT/CN2023/136107, filed on Dec. 4, 2023.

(30) Foreign Application Priority Data
Dec. 2, 2022 (WO) PCT/CN2022/136217

(51) Int. Cl. H04N 19/103; H04N 19/136; H04N 19/147; H04N 19/172; H04N 19/42; H04N 19/70

(52) U.S. Cl. CPC H04N 19/103; H04N 19/136; H04N 19/147; H04N 19/172; H04N 19/42; H04N 19/70

(57) ABSTRACT

A video coding system for universal semantic compression is disclosed. The video coding system includes a task-oriented mode decision component configured to receive an origin video and a task-oriented semantic mask as input, and progressively utilize reinforcement learning to determine a task-oriented optimal coding mode. The video coding system also includes a codec configured to compress the origin video into a bitstream based on the task-oriented optimal coding mode or decompress the bitstream into a reconstructed video based on the task-oriented optimal coding mode.

### CROSS-REFERENCE TO RELATED PATENT APPLICATIONS

This application is a continuation of International Patent Application No. PCT/CN2023/136107 filed on Dec. 4, 2023 which claims the priority to and benefits of International Patent Application No. PCT/CN2022/136217, filed on Dec. 2, 2022. All the aforementioned patent applications are hereby incorporated by reference in their entireties.

### TECHNICAL FIELD

This patent document relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a video coding system for universal semantic compression comprising: a task-oriented mode decision component configured to receive an origin video and a task-oriented semantic mask as input, and progressively utilize reinforcement learning to determine a task-oriented optimal coding mode; and a codec configured to compress the origin video into a bitstream based on the task-oriented optimal coding mode or decompress the bitstream into a reconstructed video based on the task-oriented optimal coding mode.

A second aspect relates to a method implemented on a video coding system, the method comprising: determining a task-oriented optimal coding mode by progressively utilizing reinforcement learning at a task-oriented mode decision component using an origin video and a task-oriented semantic mask as input; and performing a conversion between a visual media data and a bitstream based on the task-oriented optimal coding mode.

A third aspect relates to an apparatus for processing video data comprising: a processor; and a non-transitory memory with instructions thereon, wherein the instructions upon execution by the processor, cause the processor to implement the video coding system of or to perform the method of any of the preceding aspects.

A fourth aspect relates to a non-transitory computer readable medium comprising a computer program product for use by a video coding device, the computer program product comprising computer executable instructions stored on the non-transitory computer readable medium such that when executed by a processor cause the video coding device to implement the video coding system of or to perform the method of any of the preceding aspects.

A fifth aspect relates to a non-transitory computer-readable recording medium storing a bitstream of a video which is generated by a method performed by a video processing apparatus, wherein the method comprises: determining a task-oriented optimal coding mode by progressively utilizing reinforcement learning at a task-oriented mode decision component using an origin video and a task-oriented semantic mask as input; and generating the bitstream based on the determining.

A sixth aspect relates to a method for storing bitstream of a video comprising: determining a task-oriented optimal coding mode by progressively utilizing reinforcement learning at a task-oriented mode decision component using an origin video and a task-oriented semantic mask as input; generating the bitstream based on the determining; and storing the bitstream in a non-transitory computer-readable recording medium.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example task-oriented video semantic coding system.

FIG. 2 illustrates an example task-oriented optimal mode decision part.

FIG. 3 is a block diagram showing an example video processing system.

FIG. 4 is a block diagram of an example video processing apparatus.

FIG. 5 is a flowchart for an example method of video processing.

FIG. 6 is a block diagram that illustrates an example video coding system.

FIG. 7 is a block diagram that illustrates an example encoder.

FIG. 8 is a block diagram that illustrates an example decoder.

FIG. 9 is a schematic diagram of an example encoder.

FIG. 10 is a flowchart for an example method of video processing.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present document for ease of understanding and do not limit the applicability of techniques and embodiments disclosed in each section only to that section. Furthermore, the techniques described herein are applicable to other video codec protocols and designs.

### 1. Initial Discussion

Video coding standards [14-17] are commonly optimized for the objective/perceptual metrics, such as pixel-level metric Peak Signal to Noise Ratio (PSNR) [4-6] or perceptual-level metric Multi-Scale SSIM (MS-SSIM) [7,8]. Nevertheless, with the development of artificial intelligence, there is an increasing demand for video codecs to support the video coding for intelligent vision tasks, such as pose estimation [9], action recognition [10], and object tracking [11], as stated in Video Coding for Machines (VCM) [12, 13]. However, the optimization objectives, i.e., task-oriented semantic metrics [1], cannot be integrated into the existing video coding standards directly.

To solve the above challenges, some pioneering works [1, 2] utilize reinforcement learning to integrate semantic metrics into traditional codecs. However, they only deal with All-intra coding rather than Inter-frame coding, allowing room for task-oriented semantic video coding. Following them, the work [3] presents hierarchical reinforcement learning for the semantic video coding of video segmentation, and validates its effectiveness and efficiency on the video object segmentation problem. Nevertheless, the hierarchical mode selection strategy simplifies the complex mode decision space, so that it doesn't fit well in dynamic video which needs a more comprehensive design. Based on multi-level reinforcement learning which selects task-oriented optimal mode progressively and comprehensively, this disclosure describes a task-oriented video semantic coding system.

### 2. Detailed Description

### 2.1 Technical Field

This disclosure is in the scope of video processing technologies. Specifically, it proposes a video coding scheme for task-oriented semantic information maintenance. The compression cost is reduced significantly while the task-oriented semantic information is well preserved. It can be deployed for many intelligent vision tasks, such as pose estimation [9], action recognition [10], and object tracking [11], as stated in VCM [12].

### 2.2 Description of Related Examples

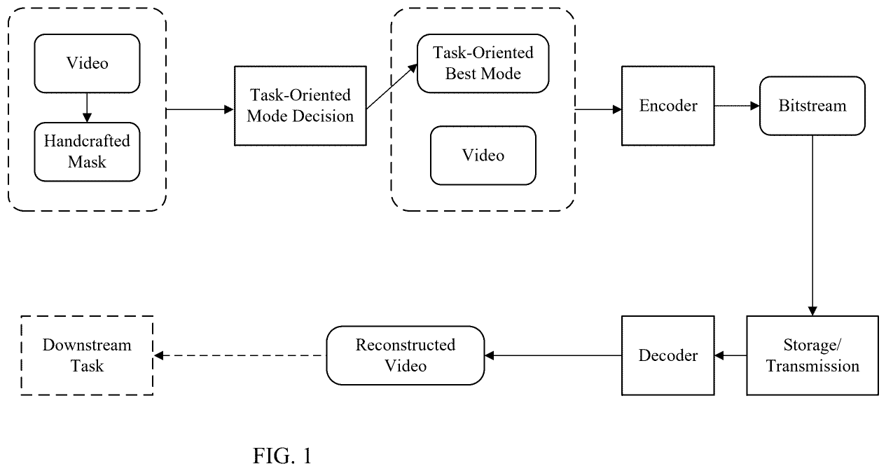

This disclosure is intended for task-oriented video semantic compression. This disclosure describes a task-oriented optimal mode selection strategy based on the multi-level reinforcement learning, which seeks to achieve the optimal rate-semantic-distortion optimization in a coarse to fine manner, as seen in FIG. 1. FIG. 1 illustrates an example task-oriented video semantic coding system. The details are as follows.

First of all, a handcrafted mask of the video is generated to indicate the semantic importance. Next, the task-oriented mode decision component takes the video and mask as input to generate a best mode. Afterward, the codec compresses the video under the selected best mode and outputs a bit stream. After storage or transmission, the bit stream is decoded for a downstream task such as Video Object Segmentation, Detection, Tracking, or reconstruction. The dashed square indicates an optional component.

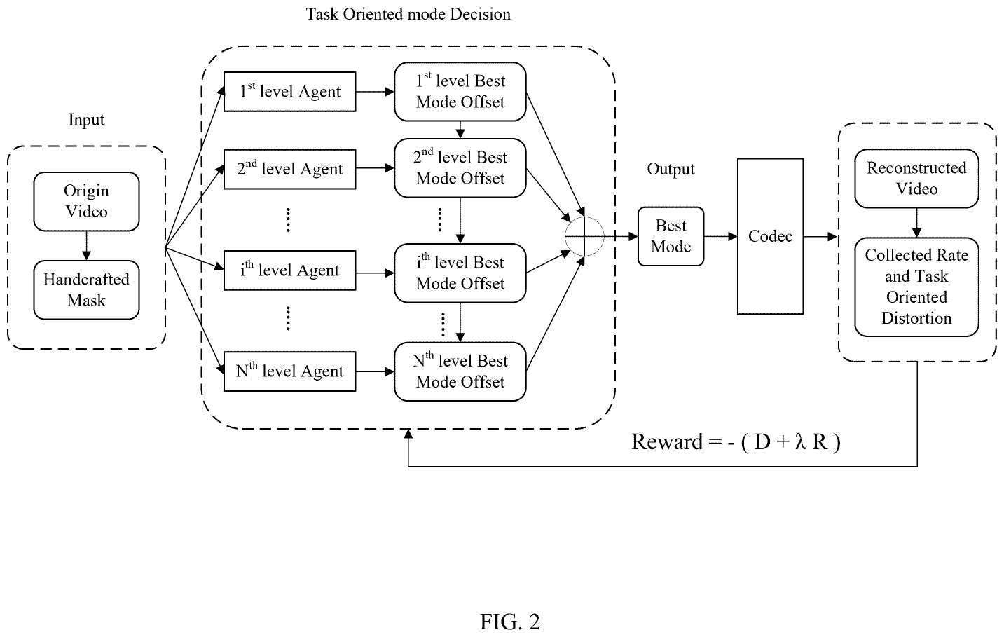

FIG. 2 illustrates an example task-oriented optimal mode decision part. The details of the task-oriented mode decision component are shown in FIG. 2. The first hindrance lies in that the mode space is exponentially proportional to the number of frames and should be simplified. However, because of the complex temporal dependency introduced by inter-prediction in video coding, the distortion in the reference area spreads to all subsequent areas. As a result, the mode space in video coding cannot be simplified as in intra coding. Taking another approach, this disclosure selects best mode in a coarse to a fine manner, with the help of multi-level reinforcement learning. The higher agent produces an optimal mode and the lower agent produces optimal mode offset with the former as the center. Each agent first extracts a feature and then uses reinforcement learning to represent the distortion propagation phenomena introduced by inter-prediction, which results in capturing the ideal rate-distortion point that minimizes rate and distortion cost. Finally, the progressively generated optimal mode offsets are summed up and then indicated to the codec to compress.

As a complement, to indicate the semantic importance for the layered agents, a handcrafted mask is generated first and fed into the agents along with the origin video. Moreover, to train the feature extractors and reinforcement agents, the calculated rate (R) and task-related distortion (D) of decompressed video are assigned to each level as a reward.

### 2.3 Description of Example Embodiments

As an embodiment of the present disclosure, the detailed description is presented as follows.

FIG. 1 illustrates an example task-oriented video semantic coding system. A handcrafted mask of the origin video is generated first to indicate semantic importance. As used herein, a handcrafted mask may be any pre-selected and/or pre-configured mask, such as a task-oriented semantic mask. The task-oriented semantic mask may be an array where each element can indicate the semantics of the sample in a corresponding location. For example, if the task is to determine a best mode for a specific foreground object, a mask can indicate the location of a specific foreground object by indicating which samples include the foreground object and which samples do not include the foreground object. Accordingly, the mask can focus the best mode selection process on samples that are relevant to a specific task. The task-oriented semantic mask can be generated by a relevant neural network based on the corresponding task. For example, when the task is object detection, an object detection neural network can determine the location of the relevant object and generate a task-oriented semantic mask that removes all samples that are not included in the object. As an example, video may include an image of a bear in a forest. If the task is to determine a best mode for coding the bear image, the object detection neural network can generate a task-oriented semantic mask that indicates all the samples of the bear and indicates all the samples of the forest. In this way, applying the mask to the origin video can effectively remove the forest from consideration leaving only the bear. In this way, any task can be represented by a task-oriented semantic mask which indicates the samples that should be considered to when determining a best mode for the task.

Next, the task-oriented mode decision component takes the video and mask as input to generate best mode. The task-oriented mode decision component is configured to select from one or more coding modes based on a task, which may be input or preconfigured. As an example, the task-oriented semantic mask can be applied to the origin video to focus the process of samples that are relevant to the task. The masked video can then be fed into a convolutional neural network to allow the neural network to perform feature extraction from the masked video in order to select a best mode. Afterward, the codec compresses the video under the selected best mode and output bit stream. After storage or transmission, the bit stream is decoded for a downstream task such as Video Object Segmentation, Detection, Tracking, or reconstruction. The dashed square indicates an optional component.

FIG. 2 illustrates an example task-oriented optimal mode decision part, which may be used to implement the task-oriented mode decision component of FIG. 1. The video and generated task-oriented semantic mask are taken as input, the task-oriented semantic mask is applied to the video to obtain a masked video, and a selected task-oriented best mode is determined for the masked video and output. To simplify decision mode space, the example separates mode space in a coarse to fine manner, with the help of multi-level reinforcement learning. The higher agent extracts a global feature from the masked video and outputs a best mode, while the lower agent extracts a local feature from the masked video and outputs a best mode offset with the former as the center in a finer manner. Each agent is composed of a feature extraction part and a reinforcement learning part that utilizes reinforcement learning to capture the best mode offset from the masked video. Then, the codec compresses the video under the selected best mode. Thereafter, the rate and task-related distortion are collected as a reward to progressively train the multi-level agents in a coarse to fine manner.

### 3. Summary of the Disclosure

This disclosure describes a general video semantic coding system that minimizes the task-oriented rate- distortion cost. With the video and handcrafted mask as input, the comprehensive task-oriented mode decision part simplifies the complex decision mode space in a coarse to fine manner, and then utilizes layered reinforcement learning agents to select the optimal mode offset progressively.

### 4. A Listing of Solutions and Embodiments

1. A video coding system for universal semantic compression is composed of the following parts: a handcrafted mask generation part; a task-oriented mode decision part, which takes the origin video and corresponding mask as input, and progressively utilizes reinforcement learning to determine the task-oriented optimal coding modes offset; and an encoding and decoding codec. The encoder compresses the video into bitstream under the selected task-oriented best coding modes, and then the decoder decompresses the bitstream into reconstructed video. The reconstructed video is usually fed into downstream semantic tasks.
1.1 A codec according to 1, wherein the codec confirms to a traditional coding standard.
1.2 A downstream task according to 1, wherein the task is semantic task, reconstruction task, or the combination of them.
1.3 A traditional coding standard according to 1.1, wherein it is High-Efficiency Video Coding (HEVC) [15], Versatile Video Coding (VVC) [16], the standard (e.g., AVS3) [17] to be finalized, or future video coding standards, and so on.
1.4 A semantic task according to 1.2, wherein the task is video object segmentation, video object tracking, action recognition and so on, or the combination of them.
1.5 A reconstruction task according to 1.2, wherein the reconstructed video has the minimized pixel-level or perceptual-level metric compared with origin video.
1.6 A pixel-level metric according to 1.4, wherein it is PSNR/mean square error (MSE) and so on.
1.7 A perceptual-level metric according to 1.4, wherein it is SSIM, MS-SSIM, Video Multi-method Assessment Fusion (VMAF), Learned Perceptual Image Patch Similarity (LPIPS), and so on.
2. A task-oriented mode decision part confirming to 1 is composed of the following parts: N reinforcement learning agents which output N best mode offset in a coarse to fine manner; and a training strategy that trains the N agents to output N best mode offset in a coarse to fine manner.
2.1 A task-oriented mode decision part according to 2, wherein N=3.
2.2 A task-oriented mode decision part according to 2.1, wherein the 1st level agent output the best mode for a group of pictures (GOP), the 2nd level agent output the best mode offset for each frame in the GOP, and the 3rd level agent output the best mode offset for the background and foreground of each frame.
2.3 A mode according to 2, wherein the mode is allocated bitrate for each level.
2.4 A mode according to 2, wherein the mode is selected quantization parameter for each level.
2.5 A mode according to 2, wherein the mode is selected Lagrange multiplier for each level.
3. A training strategy confirming to 2 is composed of the following parts: a 1st level agent takes the video and its mask as input, extracts 1st-level coarse feature, and then outputs a 1st level best mode; a 2nd level agent tasks the video and its mask as input, extracts 2nd-level fine feature, and then output 2nd level best mode offset with the 1st level best mode as center; a N-th level agent tasks the video and its mask as input, extracts (N-1) th-level finer feature, and then outputs Nth level best mode offset with the (N-1) the level best mode as center. The N-th best mode offset are collected to form the finest best mode for coding, and then a codec compresses the origin video under the best mode, the decompressed video is used for downstream tasks and distortion and rate are collected; and the distortion and rate are assigned into different level agent to train the agent.
3.1 An agent according to 3, wherein it is a reinforcement learning agent, such as deep Q network (DQN), Advantage Actor Critic (A2C), or Asynchronous Advantage Actor Critic (A3C), and so on.

### 5. References

[1] Li X, Shi J, Chen Z. Task-driven semantic coding via reinforcement learning[J]. IEEE Transactions on Image Processing, 2021, 30:6307-6320.
[2] Shi J, Chen Z. Reinforced bit allocation under task-driven semantic distortion metrics[C]//2020 IEEE international symposium on circuits and systems (ISCAS). IEEE, 2020:1-5.
[3] Xie G, Li X, Lin S, et al. Hierarchical Reinforcement Learning Based Video Semantic Coding for Segmentation[J]. arXiv preprint arXiv:2208.11529, 2022.
[4] Hu J H, Peng W H, Chung C H. Reinforcement learning for HEVC/H. 265 intra-frame rate control[C]//2018 IEEE International Symposium on Circuits and Systems (ISCAS). IEEE, 2018:1-5.
[5] Chen L C, Hu J H, Peng W H. Reinforcement learning for HEVC/H. 265 frame-level bit allocation[C]//2018 IEEE 23rd International Conference on Digital Signal Processing (DSP). IEEE, 2018:1-5.
[6] Zhou M, Wei X, Kwong S, et al. Rate control method based on deep reinforcement learning for dynamic video sequences in HEVC[J]. IEEE Transactions on Multimedia, 2020, 23:1106-1121.
[7] Wang S, Rehman A, Wang Z, et al. Rate-SSIM optimization for video coding[C]//2011 IEEE International Conference on Acoustics, Speech and Signal Processing (ICASSP). IEEE, 2011:833-836.
[8] Dai W, Au O C, Zhu W, et al. SSIM-based rate-distortion optimization in H. 264[C]//2014 IEEE International Conference on Acoustics, Speech and Signal Processing (ICASSP). IEEE, 2014:7343-7347.
[9] Wang J, Sun K, Cheng T, et al. Deep high-resolution representation learning for visual recognition [J]. IEEE transactions on pattern analysis and machine intelligence, 2020, 43(10): 3349-3364.
[10] Feichtenhofer C, Fan H, Malik J, et al. Slowfast networks for video recognition[C]//Proceedings of the IEEE/CVF international conference on computer vision. 2019:6202-6211.
[11] Wang Z, Zheng L, Liu Y, et al. Towards real-time multi-object tracking[C]//European Conference on Computer Vision. Springer, Cham, 2020:107-122.
[12] Zhang Y. Video Coding for Machines[C]//ITU Workshop on “The future of media. 2019.
[13] Wood D. Task Oriented Video Coding: A Survey[J]. arXiv preprint arXiv:2208.07313, 2022.
[14] Wiegand T, Sullivan G J, Bjontegaard G, et al. Overview of the H. 264/AVC video coding standard[J]. IEEE Transactions on circuits and systems for video technology, 2003, 13(7): 560-576.
[15] Sullivan G J, Ohm J R, Han W J, et al. Overview of the high efficiency video coding (HEVC) standard[J]. IEEE Transactions on circuits and systems for video technology, 2012, 22(12): 1649-1668.
[16] Bross B, Wang Y K, Ye Y, et al. Overview of the versatile video coding (VVC) standard and its applications[J]. IEEE Transactions on Circuits and Systems for Video Technology, 2021, 31(10): 3736-3764.
[17] Fan L, Ma S, Wu F. Overview of AVS video standard[C] //2004 IEEE International Conference on Multimedia and Expo (ICME)(IEEE Cat. No. 04TH8763). IEEE, 2004, 1:423-426.

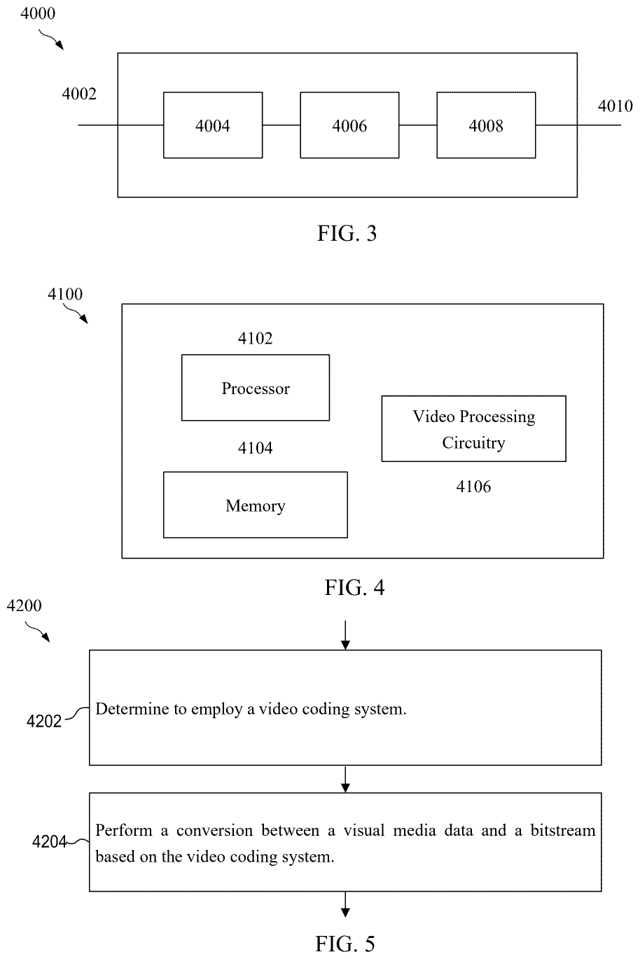

FIG. 3 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present document. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include SATA serial advanced technology attachment (SATA), peripheral component interconnect (PCI), integrated drive electronics (IDE) interface, and the like. The techniques described in the present document may be embodied in various electronic devices such as mobile phones, laptops, smartphones or other devices that are capable of performing digital data processing and/or video display.

FIG. 4 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present document. The memory (memories) 4104 may be used for storing data and code used for implementing the methods and techniques described herein. The video processing circuitry 4106 may be used to implement, in hardware circuitry, some techniques described in the present document. In some embodiments, the video processing circuitry 4106 may be at least partly included in the processor 4102, e.g., a graphics co-processor.

FIG. 5 is a flowchart for an example method 4200 of video processing. The method 4200 includes determining to employ a video coding system at step 4202. The video coding system includes a handcrafted mask generation component. The video coding system also includes a task-oriented mode decision component configured to receive an origin video and a corresponding mask as input, and progressively utilize reinforcement learning to determine a task-oriented optimal coding mode offset. The video coding system also includes an encoding codec configured to compress the origin video into a bitstream under determined task-oriented optimal coding modes. The video coding system also includes a decoding code configured to decompress the bitstream into a reconstructed video, wherein the reconstructed video is fed into downstream tasks. A conversion is performed between a visual media data and a bitstream based on the video coding system at step 4204. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

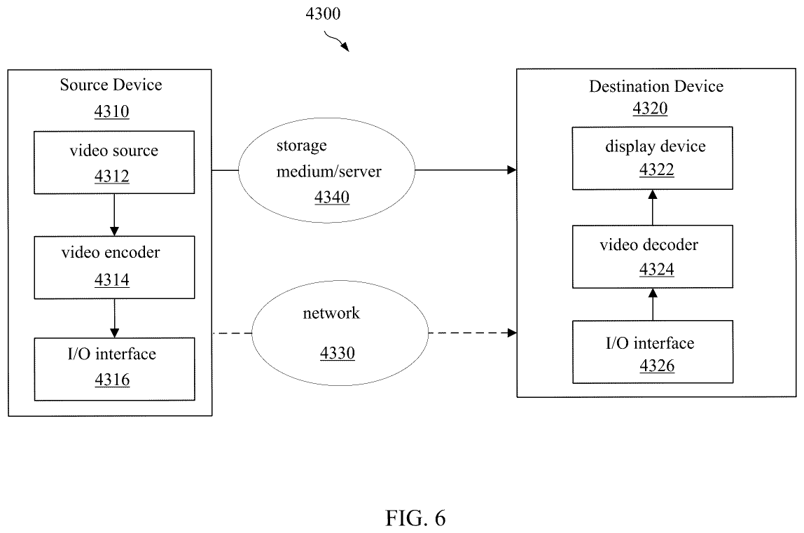

FIG. 6 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVM) standard and other current and/or further standards.

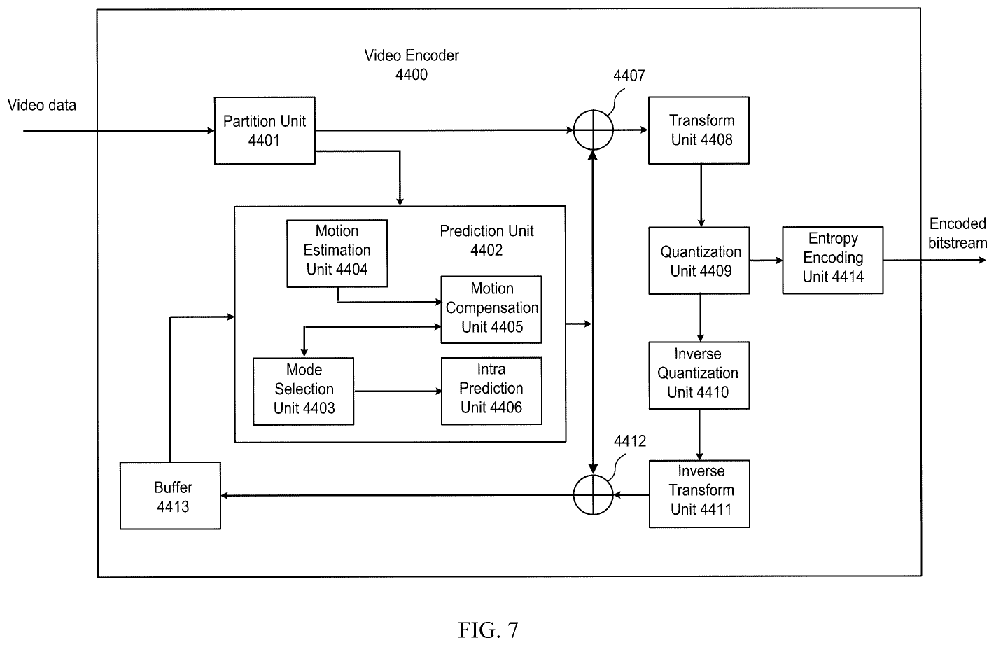

FIG. 7 is a block diagram illustrating an example of video encoder 4400, which may be video encoder 4314 in the system 4300 illustrated in FIG. 6. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

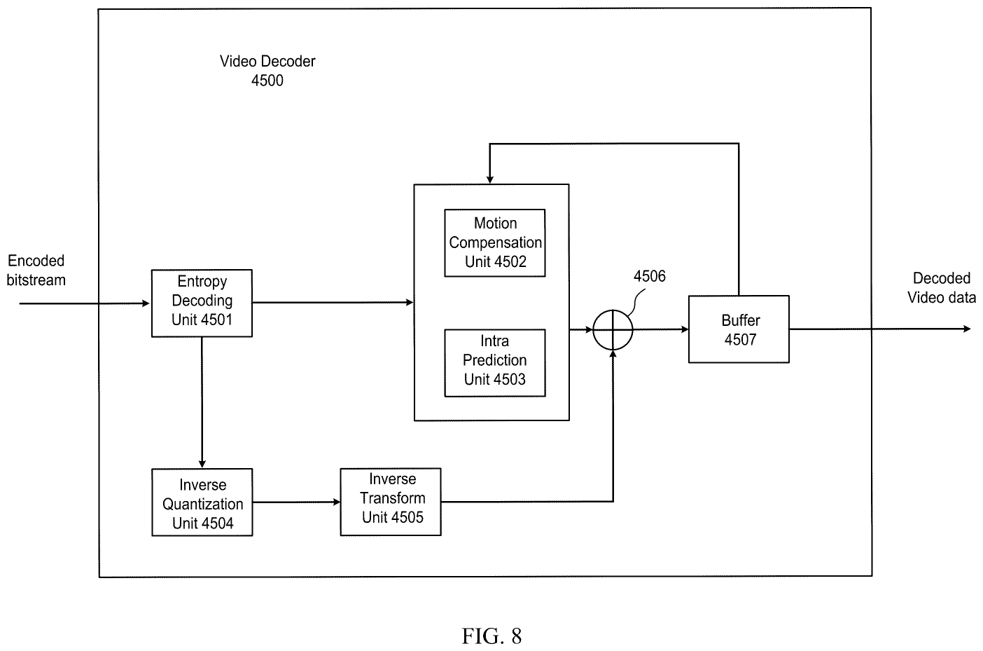

FIG. 8 is a block diagram illustrating an example of video decoder 4500 which may be video decoder 4324 in the system 4300 illustrated in FIG. 6. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

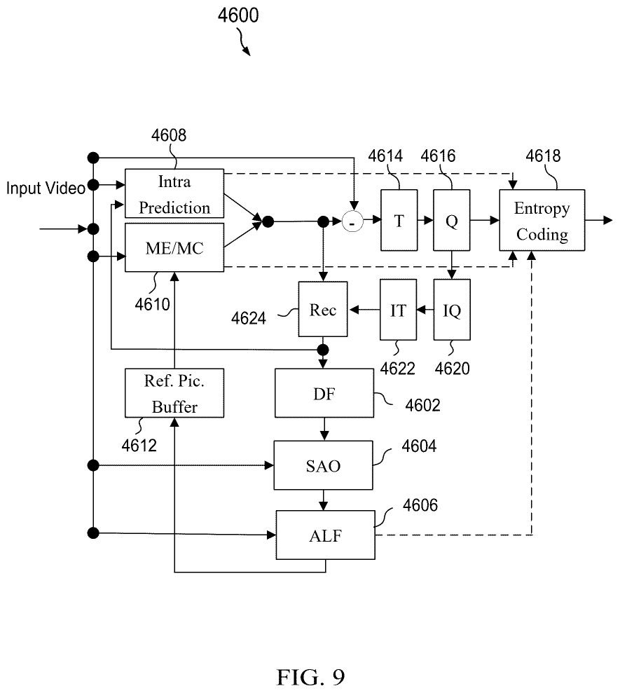

FIG. 9 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

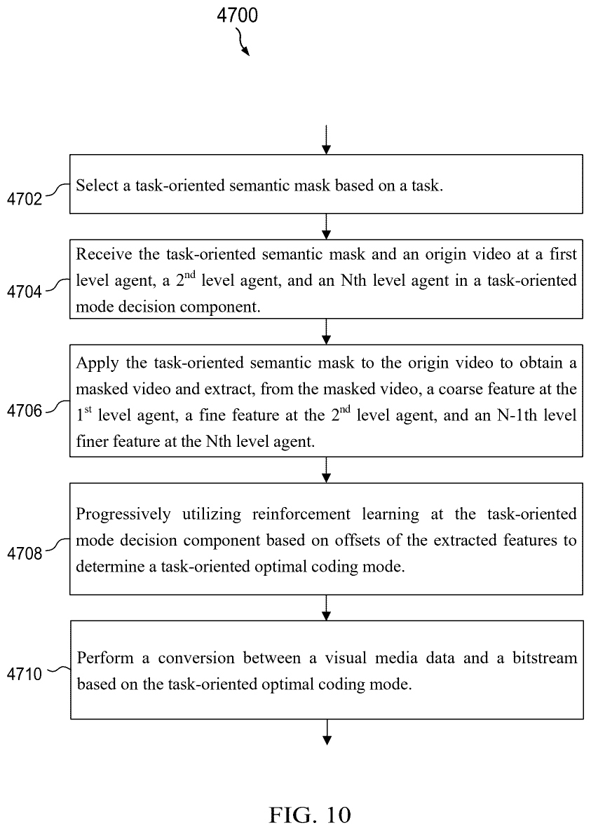

FIG. 10 is a flowchart for an example method 4700 of video processing. The method 4700 includes selecting a task-oriented semantic mask based on a task at step 4702. The mask can be selected to focus on samples that are related to a task. The task-oriented semantic mask can be selected and/or generated by a relevant neural network. At step 4704, the task-oriented semantic mask and an origin video is received at a first level agent, a 2^{nd} level agent, and an Nth level agent in a task-oriented mode decision component. At step 4706, the task-oriented semantic mask is applied to the origin video to obtain a masked video. The agents then extract, from the masked video, a coarse feature at the 1^{st} level agent, a fine feature at the 2^{nd} level agent, and an N-1th level finer feature at the Nth level agent. At step 4708, reinforcement learning is progressively utilized at the task-oriented mode decision component based on offsets of the extracted features to determine a task-oriented optimal coding mode. A conversion is performed between a visual media data and a bitstream based on the task-oriented optimal coding mode at step 4710. The conversion of step 4710 may include encoding at an encoder or decoding at a decoder, depending on the example.

It should be noted that the method 4700 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4700 can be performed by a non-transitory computer readable medium comprising a computer program product for use by a video coding device. The computer program product comprises computer executable instructions stored on the non-transitory computer readable medium such that when executed by a processor cause the video coding device to perform the method 4700.

A listing of solutions preferred by some examples is provided next.

The following solutions show examples of techniques discussed herein.
1. A video coding system for universal semantic compression comprising: a handcrafted mask generation component; a task-oriented mode decision component configured to receive an origin video and a corresponding mask as input, and progressively utilize reinforcement learning to determine a task-oriented optimal coding mode offset; an encoding codec configured to compress the origin video into a bitstream under determined task-oriented optimal coding modes; and a decoding code configured to decompress the bitstream into a reconstructed video, wherein the reconstructed video is fed into downstream tasks.
2. The video coding system of solution 1, wherein the codec conforms to a coding standard.
3. The video coding system of any of solutions 1-2, wherein the downstream tasks include a semantic task, a reconstruction task, or a combination thereof.
4. The video coding system of any of solutions 1-3, wherein the coding standard is High-Efficiency Video Coding (HEVC), Versatile Video Coding (VVC), Third Generation Audio Video Standard (AVS3), or combinations thereof.
5. The video coding system of any of solutions 1-4, wherein the downstream tasks includes video object segmentation, video object tracking, action recognition, or a combination thereof.
6. The video coding system of any of solutions 1-5, wherein the downstream tasks includes a reconstruction task, and wherein the reconstructed video has a minimized pixel-level or perceptual-level metric compared with the origin video.
7. The video coding system of any of solutions 1-6, wherein a pixel-level metric is employed, and wherein the pixel-level metric includes peak signal to noise ratio (PSNR), mean square error (MSE), or combinations thereof.
8. The video coding system of any of solutions 1-7, wherein a perceptual-level metric is employed, and wherein the perceptual-level metric includes structural similarity index measure (SSIM), Multi-Scale SSIM (MS-SSIM), Video Multi-method Assessment Fusion (VMAF), Learned Perceptual Image Patch Similarity (LPIPS), or combinations thereof.
9. The video coding system of any of solutions 1-8, further comprising a task-oriented mode decision component comprising: N reinforcement learning agents configured to output N best mode offsets in a coarse to fine manner; and a training strategy component configured to train the N agents to output N best mode offsets in a coarse to fine manner.
10. The video coding system of any of solutions 1-9, wherein N=3.
11. The video coding system of any of solutions 1-10, wherein a 1st level agent outputs the best mode for a group of pictures (GOP), wherein a 2nd level agent outputs a best mode offset for each frame in the GOP, and wherein a 3rd level agent outputs a best mode offset for a background and a foreground of each frame.
12. The video coding system of any of solutions 1-11, wherein a mode is allocated based on bitrate for each level.
13. The video coding system of any of solutions 1-12, wherein a mode is selected based on quantization parameters for each level.
14. The video coding system of any of solutions 1-13, wherein a mode is selected based on a Lagrange multiplier for each level.
15. The video coding system of any of solutions 1-14, wherein a 1st level agent is configured to receive a video and a mask as input, extract 1st-level coarse features, and then output a 1st level best mode, wherein a 2nd level agent is configured to receive the video and the mask as input, extract a 2nd-level fine feature, and output a 2nd level best mode offset with the 1st level best mode as a center, wherein a N-th level agent is configured to receive the video and the mask as input, extract a (N-1)th-level finer feature, and output a Nth level best mode offset with a (N-1)th level best mode as a center, wherein the N-th best mode offset are collected to form a finest best mode for coding, wherein a codec is configured to compress the origin video using the finest best mode, wherein a decompressed video is used for downstream tasks, distortion collection, and rate collection, and wherein the distortion and rate are assigned into a different level agent to train the different level agent.
16. The video coding system of any of solutions 1-15, wherein the agents include a reinforcement learning agent, and wherein the reinforcement learning agent includes deep Q network (DQN), Advantage Actor Critic (A2C), or Asynchronous Advantage Actor Critic (A3C).
17. A method comprising: determining to employ a video coding system of any of solutions 1-16; and performing a conversion between a visual media data and a bitstream based on the video coding system.
18. An apparatus for processing video data comprising: a processor; and a non-transitory memory with instructions thereon, wherein the instructions upon execution by the processor, cause the processor to implement the video coding system of any of solutions 1-16.
19. A non-transitory computer readable medium comprising a computer program product for use by a video coding device, the computer program product comprising computer executable instructions stored on the non-transitory computer readable medium such that when executed by a processor cause the video coding device to implement the video coding system of any of solutions 1-16.
20. A non-transitory computer-readable recording medium storing a bitstream of a video which is generated by a method performed by a video processing apparatus, wherein the method comprises: determining to employ a video coding system of any of solutions 1-16; and generating the bitstream based on the determining.
21. A method for storing bitstream of a video comprising: determining to employ a video coding system of any of solutions 1-16; generating the bitstream based on the determining; and storing the bitstream in a non-transitory computer-readable recording medium.
22. A method, apparatus, or system described in the present document.

The following solutions show further examples of techniques discussed herein.
1. A video coding system for universal semantic compression comprising: a task-oriented mode decision component configured to receive an origin video and a task-oriented semantic mask as input, and progressively utilize reinforcement learning to determine a task-oriented optimal coding mode; and a codec configured to compress the origin video into a bitstream based on the task-oriented optimal coding mode or decompress the bitstream into a reconstructed video based on the task-oriented optimal coding mode.
2. The video coding system of solution 1, further comprising a mask generation component configured to select a task-oriented semantic mask based on a task.
3. The video coding system of any of solutions 1-2, wherein the codec conforms to a coding standard.
4. The video coding system of any of solutions 1-3, wherein the coding standard is High-Efficiency Video Coding (HEVC), Versatile Video Coding (VVC), Third Generation Audio Video Standard (AVS3), or combinations thereof.
5. The video coding system of any of solutions 1-4, wherein the reconstructed video is fed into downstream tasks that include a semantic task, a reconstruction task, or a combination thereof.
6. The video coding system of any of solutions 1-5, wherein the reconstructed video is fed into downstream tasks that include video object segmentation, video object tracking, action recognition, or a combination thereof.
7. The video coding system of any of solutions 1-6, wherein the reconstructed video is fed into downstream tasks that include a reconstruction task, and wherein the reconstructed video has a minimized pixel-level metric or perceptual-level metric compared with the origin video.
8. The video coding system of any of solutions 1-7, and wherein the pixel-level metric includes peak signal to noise ratio (PSNR), mean square error (MSE), or combinations thereof.
9. The video coding system of any of solutions 1-8, wherein the perceptual-level metric includes structural similarity index measure (SSIM), Multi-Scale SSIM (MS-SSIM), Video Multi-method Assessment Fusion (VMAF), Learned Perceptual Image Patch Similarity (LPIPS), or combinations thereof.
10. The video coding system of any of solutions 1-9, wherein the task-oriented mode decision component comprises N reinforcement learning agents configured to output N best mode offsets for the origin video based on the task-oriented semantic mask in a coarse to fine manner.
11. The video coding system of any of solutions 1-10, wherein the task-oriented mode decision component further comprises a training strategy component configured to train the N agents to output the N best mode offsets in a coarse to fine manner.
12. The video coding system of any of solutions 1-11, wherein N=3.
13. The video coding system of any of solutions 1-12, wherein a 1st level agent outputs a best mode for a group of pictures (GOP), wherein a 2nd level agent outputs a best mode offset for each frame in the GOP, and wherein a 3rd level agent outputs a best mode offset for a background and a foreground of each frame.
14. The video coding system of any of solutions 1-13, wherein a best mode is allocated based on bitrate for each level agent, selected based on quantization parameters for each level agent, or selected based on a Lagrange multiplier for each level agent.
15. The video coding system of any of solutions 1-14, wherein a 1st level agent is configured to receive the origin video and the task-oriented semantic mask as input, extract a 1st-level coarse feature from the origin video based on the task-oriented semantic mask, and then output a 1st level best mode based on the 1st-level coarse feature, wherein a 2nd level agent is configured to receive the origin video and the task-oriented semantic mask as input, extract a 2nd-level fine feature from the origin video based on the task-oriented semantic mask, and output a 2nd level best mode offset based on the 2nd-level fine feature with the 1st level best mode as a center, wherein a N-th level agent is configured to receive the origin video and the task-oriented semantic mask as input, extract a (N-1)th-level finer feature from the origin video based on the task-oriented semantic mask, and output a Nth level best mode offset based on the (N-1)th-level finer feature with a (N-1)th level best mode as a center, wherein the N-th level best mode offset is collected to form a finest best mode for coding, wherein the codec is configured to compress the origin video using the finest best mode, wherein a decompressed video is used for downstream tasks, distortion collection, and rate collection, and wherein the distortion and rate are assigned into a different level agents to train the different level agents.
16. The video coding system of any of solutions 1-15, wherein the leaning agents are reinforcement learning agents, and wherein the reinforcement learning agents include a deep Q network (DQN), an Advantage Actor Critic (A2C), or an Asynchronous Advantage Actor Critic (A3C).
17. A method implemented on a video coding system, the method comprising: determining a task-oriented optimal coding mode by progressively utilizing reinforcement learning at a task-oriented mode decision component using an origin video and a task-oriented semantic mask as input; and performing a conversion between a visual media data and a bitstream based on the task-oriented optimal coding mode.
18. The method of claim 17, further comprising compressing the origin video into a bitstream based on the task-oriented optimal coding mode or decompressing the bitstream into a reconstructed video based on the task-oriented optimal coding mode.
19. The method of any of solutions 17-18, further comprising selecting a task-oriented semantic mask based on a task.
20. The method of any of solutions 17-19, wherein the codec conforms to a coding standard, and wherein the coding standard is High-Efficiency Video Coding (HEVC), Versatile Video Coding (VVC), Third Generation Audio Video Standard (AVS3), or combinations thereof.
21. The method of any of solutions 17-20, wherein the reconstructed video is fed into downstream tasks that include a semantic task, a reconstruction task, video object segmentation, video object tracking, action recognition, or a combination thereof.
22. The method of any of solutions 17-21, wherein the reconstructed video is fed into downstream tasks that include a reconstruction task, and wherein the reconstructed video has a minimized pixel-level metric or perceptual- level metric compared with the origin video.
23. The method of any of solutions 17-22, and wherein the pixel-level metric includes peak signal to noise ratio (PSNR), mean square error (MSE), or combinations thereof.
24. The method of any of solutions 17-23, wherein the perceptual-level metric includes structural similarity index measure (SSIM), Multi-Scale SSIM (MS-SSIM), Video Multi-method Assessment Fusion (VMAF), Learned Perceptual Image Patch Similarity (LPIPS), or combinations thereof.
25. The method of any of solutions 17-24, wherein the task-oriented mode decision component comprises N reinforcement learning agents configured to output N best mode offsets for the origin video based on the task-oriented semantic mask in a coarse to fine manner.
26. The method of any of solutions 17-25, wherein the task-oriented mode decision component further comprises a training strategy component configured to train the N agents to output the N best mode offsets in a coarse to fine manner.
27. The method of any of solutions 17-26, wherein N=3.
28. The method of any of solutions 17-27, wherein a 1st level agent outputs a best mode for a group of pictures (GOP), wherein a 2nd level agent outputs a best mode offset for each frame in the GOP, and wherein a 3rd level agent outputs a best mode offset for a background and a foreground of each frame.
29. The method of any of solutions 17-28, wherein a best mode is allocated based on bitrate for each level agent, selected based on quantization parameters for each level agent, or selected based on a Lagrange multiplier for each level agent.
30. The method of any of solutions 17-29, further comprising: receiving the origin video and the task-oriented semantic mask as input at a 1st level agent, extracting a 1st-level coarse feature from the origin video based on the task-oriented semantic mask, and then outputting a 1st level best mode based on the 1st-level coarse feature; receiving the origin video and the task-oriented semantic mask as input at a 2nd level agent, extracting a 2nd-level fine feature from the origin video based on the task-oriented semantic mask, and outputting a 2nd level best mode offset based on the 2nd-level fine feature with the 1st level best mode as a center; and receiving the origin video and the task-oriented semantic mask as input at a N-th level agent, extracting a (N-1)th-level finer feature from the origin video based on the task-oriented semantic mask, and output a Nth level best mode offset based on the (N-1)th-level finer feature with a (N-1)th level best mode as a center, wherein the N-th level best mode offset is collected to form a finest best mode for coding, wherein the codec compresses the origin video using the finest best mode, wherein a decompressed video is used for downstream tasks, distortion collection, and rate collection, and wherein the distortion and rate are assigned into a different level agents to train the different level agents.
31. The method of any of solutions 17-30, wherein the leaning agents are reinforcement learning agents, and wherein the reinforcement learning agents include a deep Q network (DQN), an Advantage Actor Critic (A2C), or an Asynchronous Advantage Actor Critic (A3C).
32. The method of any of solutions 1-31, wherein the conversion includes encoding the visual media data into the bitstream.
33. The method of any of solutions 1-31, wherein the conversion includes decoding the visual media data from the bitstream.
34. An apparatus for processing video data comprising: a processor; and a non-transitory memory with instructions thereon, wherein the instructions upon execution by the processor, cause the processor to implement the video coding system of any of solutions 1-16 or to perform the method of any of solutions 17-33.
35. A non-transitory computer readable medium comprising a computer program product for use by a video coding device, the computer program product comprising computer executable instructions stored on the non-transitory computer readable medium such that when executed by a processor cause the video coding device to implement the video coding system of any of solutions 1-16 or to perform the method of any of solutions 17-33.
36. A non-transitory computer-readable recording medium storing a bitstream of a video which is generated by a method performed by a video processing apparatus, wherein the method comprises: determining a task- oriented optimal coding mode by progressively utilizing reinforcement learning at a task-oriented mode decision component using an origin video and a task-oriented semantic mask as input; and generating the bitstream based on the determining.
37. A method for storing bitstream of a video comprising: determining a task-oriented optimal coding mode by progressively utilizing reinforcement learning at a task-oriented mode decision component using an origin video and a task-oriented semantic mask as input; generating the bitstream based on the determining; and storing the bitstream in a non-transitory computer-readable recording medium.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present document, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method of processing visual media data, comprising:
determining a task-oriented optimal coding mode by progressively utilizing reinforcement learning at a task- oriented mode decision component using an origin video and a task-oriented semantic mask as input; and
performing a conversion between the visual media data and a bitstream based on the task-oriented optimal coding mode.

2. The method of claim 1, further comprising compressing the origin video into a bitstream based on the task- oriented optimal coding mode or decompressing the bitstream into a reconstructed video based on the task-oriented optimal coding mode by a codec.

3. The method of claim 1, further comprising selecting the task-oriented semantic mask based on a task by a mask generation component.

4. The method of claim 2, wherein the codec conforms to a coding standard, and wherein the coding standard is High-Efficiency Video Coding (HEVC), Versatile Video Coding (VVC), Third Generation Audio Video Standard (AVS3), or combinations thereof.

5. The method of claim 2, wherein the reconstructed video is fed into downstream tasks that include a semantic task, a reconstruction task, or a combination thereof, and wherein the semantic task includes video object segmentation, video object tracking, action recognition, or a combination thereof.

6. The method of claim 2, wherein the reconstructed video is fed into downstream tasks that include a reconstruction task, and wherein the reconstructed video has a minimized pixel-level metric or a minimized perceptual-level metric compared with the origin video.

7. The method of claim 6, and wherein the pixel-level metric includes peak signal to noise ratio (PSNR), mean square error (MSE), or combinations thereof.

8. The method of claim 6, wherein the perceptual-level metric includes structural similarity index measure (SSIM), Multi-Scale SSIM (MS-SSIM), Video Multi-method Assessment Fusion (VMAF), Learned Perceptual Image Patch Similarity (LPIPS), or combinations thereof.

9. The method of claim 1, wherein the task-oriented mode decision component comprises:
N reinforcement learning agents configured to output N best mode offsets for the origin video based on the task-oriented semantic mask in a coarse to fine manner.

10. The method of claim 9, wherein the task-oriented mode decision component further comprises a training strategy component configured to train the N reinforcement learning agents to output the N best mode offsets in a coarse to fine manner.

11. The method of claim 9, wherein N=3.

12. The method of claim 2, wherein a 1st level agent outputs a best mode for a group of pictures (GOP), a 2nd level agent outputs a best mode offset for each frame in the GOP, and a 3rd level agent outputs a best mode offset for a background and a foreground of each frame.

13. The method of claim 2, wherein a best mode is allocated based on bitrate for each level agent, selected based on quantization parameters for each level agent, or selected based on a Lagrange multiplier for each level agent.

14. The method of claim 2, further comprising:
receiving, by a 1st level agent, the origin video and the task-oriented semantic mask as input, extracting a 1st-level coarse feature from the origin video based on the task-oriented semantic mask, and then outputting a 1st level best mode based on the 1st-level coarse feature;
receiving, by a 2nd level agent, the origin video and the task-oriented semantic mask as input, extracting a 2nd-level fine feature from the origin video based on the task-oriented semantic mask, and outputting a 2nd level best mode offset based on the 2nd-level fine feature with the 1st level best mode as a center; and
receiving, by a N-th level agent, the origin video and the task-oriented semantic mask as input, extracting a (N-1)th-level finer feature from the origin video based on the task-oriented semantic mask, and output a Nth level best mode offset based on the (N-1)th-level finer feature with a (N-1)th level best mode as a center,
wherein the N-1th level best mode offset is collected to form a finest best mode for coding,
wherein the codec compresses the origin video using the finest best mode,
wherein a decompressed video is used for downstream tasks, and a distortion and a rate are collected, and
wherein the distortion and the rate are assigned into different level agents to train the different level agents.

15. The method of claim 2, wherein the reinforcement learning agents include a deep Q network (DQN), an Advantage Actor Critic (A2C), or an Asynchronous Advantage Actor Critic (A3C).

16. The method of claim 1, wherein the conversion includes encoding the visual media data into the bitstream.

17. The method of claim 1, wherein the conversion includes decoding the visual media data from the bitstream.

18. An apparatus for processing video data comprising a processor and a non-transitory memory with instructions thereon, wherein the instructions upon execution by the processor, cause the processor to implement:
determining a task-oriented optimal coding mode by progressively utilizing reinforcement learning at a task-oriented mode decision component using an origin video and a task-oriented semantic mask as input; and
performing a conversion between visual media data and a bitstream based on the task-oriented optimal coding mode.

19. The apparatus of claim 18, wherein the instructions upon execution by the processor, further cause the processor to implement:
compressing the origin video into a bitstream based on the task-oriented optimal coding mode or decompressing the bitstream into a reconstructed video based on the task-oriented optimal coding mode by a codec; and
selecting the task-oriented semantic mask based on a task by a mask generation component.

20. A non-transitory computer-readable recording medium storing a bitstream of a video which is generated by a method performed by a video processing apparatus, wherein the method comprises:
determining a task-oriented optimal coding mode by progressively utilizing reinforcement learning at a task-oriented mode decision component using an origin video and a task-oriented semantic mask as input; and
generating the bitstream based on the task-oriented optimal coding mode.
